(19) United States
(12) Patent Application Publication
(10) Pub. No.: US 2014/0213205 A1
(43) Pub. Date: Jul. 31, 2014

(54) APPARATUS, SYSTEM AND METHOD FOR A RADIO WITH MULTICHANNEL CONTENT INDICATION

(71) Applicant: DRC, LLC, Alpharetta, GA (US)

(72) Inventor: David A. Kennedy, Alpharetta, GA (US)

(21) Appl. No.: 14/168,616

(22) Filed: Jan. 30, 2014

Related U.S. Application Data
(60) Provisional application No. 61/758,505, filed on Jan. 30, 2013.

(51) Int. Cl. H04H 60/37; H04H 40/00

(52) U.S. Cl. CPC H04H 60/372; H04H 40/00
USPC 455/154.1

(57) ABSTRACT

An apparatus, system and method to indicate to the user content that is actively occurring at any given time on multiple available entertainment channels in addition to the one then being listened to/watched by the user. Such channels may include the user's preprogrammed channels. The disclosure further includes an engine, system, and method to automatically change between channels when at least one indicator indicates an occurrence, such as the start of a commercial break, and the end of an occurrence, such as the end of a commercial break, to a radio that includes the present invention.

### CROSS-REFERENCE TO RELATED APPLICATIONS

This application claims priority to U.S. Provisional Patent Application No. 61/758,505, filed entitled Apparatus, System and Method for a Radio with Multichannel Content Indication, filed Jan. 30, 2013, the entire contents of which is incorporated by reference herein.

### BACKGROUND

1. Field of the Disclosure

The instant disclosure relates to electronic entertainment devices, and, in particular, to apparatuses, systems and methods for a radio with multichannel content indication.

2. Background of the Disclosure

The presence of advanced radio systems in vehicles, and more particularly satellite radio systems in vehicles, has become ubiquitous in the current environment of advanced transportation technology. As used herein, the phrase “satellite radio” may also include standard radio, HD radio, or other types of available in vehicle radio, as applicable on a case-by-case basis with respect to the individual aspects discussed herein.

More particularly, it is typical that a user in-vehicle will listen to, for example, Sirius XM radio during “drive time”. It is also frequent that, in such a circumstance, the user may listen to multiple channels available on the satellite radio during drive time, wherein the user may switch between channels for particular purposes. A most frequent among these purposes is that a channel currently being listened to by the in-vehicle user switches from programming content to a commercial break, whereupon the listening user switches to a different channel in order to access programming content rather than the commercials. Further, such switching may most conveniently occur as between preprogrammed radio stations that are programmed into the vehicle radio. For example, a user may listen to Fox News, which may be radio channel 85, and may also, in this example, be user preprogrammed channel 1 in vehicle. When this preprogrammed channel 1 goes to commercial from programming, the user may switch to preprogrammed channel 2 to check if preprogrammed channel 2 has programming then available. Preprogrammed (“PP”) channel 2 may constitute, for example, a country music channel, which may be radio channel 111.

In such situations, the user may prefer to listen to the programming on PP channel 1, and as such may endeavor to estimate when the commercials have ended on PP channel 1, at which time the user may switch back from preprogrammed channel 2 to preprogrammed PP channel 1. In such an embodiment, if commercials are still on PP channel 1 or were on PP channel 2 when the user attempted to switch to PP channel 2, the user may switch to other preprogrammed channels, such as a third or fourth PP channel, all in an effort to avoid commercials but with the intent to switch back to the most preferred channel, PP channel 1 in this example, when programming returns on PP channel 1.

However, seemingly more often than not, the user forgets to switch back to PP channel 1 in a timely manner, or over-estimates the length of the commercial break on channel 1. As such, the user misses the preferred programming on PP channel 1 that occurred immediately following the commercial break.

Accordingly, there is a need for an engine, apparatus, system and method to assess the correct time for a user to switch between channels, and most preferably to return to a most preferred channel as proximate as possible to the end of an occurrence, such as a commercial break.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates aspects of the disclosed embodiments;

FIG. 2 illustrates aspects of the disclosed embodiments; and

FIG. 3 illustrates aspects of the disclosed embodiments.

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical electronic entertainment apparatuses, systems, and methods, as well as in mobile devices, transportation machines, and in telecommunications servers and telecommunications generally. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

The disclosure is and includes an apparatus, system and method to indicate to the user content that is actively occurring at any given time on multiple available entertainment channels in addition to the one then being listened to/watched by the user. Such channels may preferably include the user's preprogrammed channels. The disclosure further includes an engine, system, and method to automatically change between channels when at least one indicator indicates an occurrence, such as the start of a commercial break, and the end of an occurrence, such as the end of a commercial break, to a radio that includes the present invention.

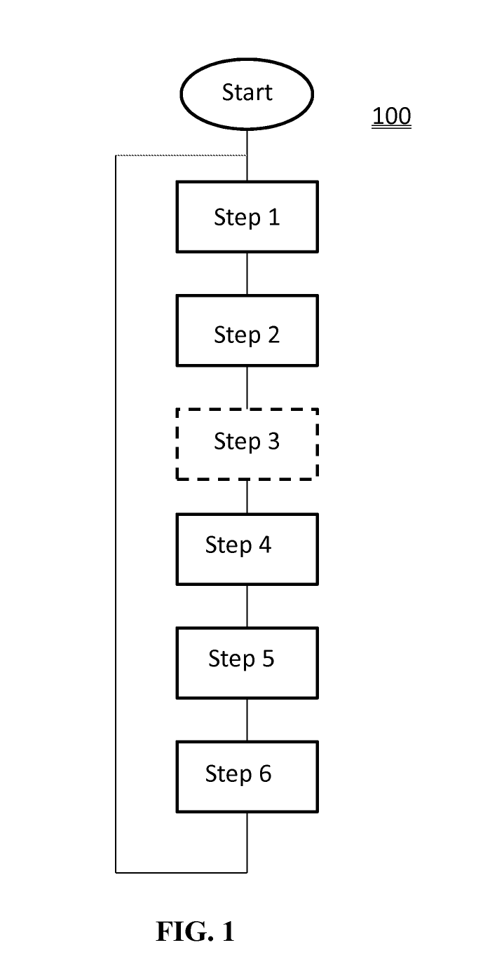

FIG. 1 is a flow diagram of a method according to the disclosure. In the illustration, step 1 indicates the occurrence of a commercial break on a preprogrammed channel. At Step 2, upon occurrence of the commercial break, the radio receives an indicator that a commercial break is occurring. Such an indicator may include, for example, data embedded in a signal received by the radio, such as data embedded in the received programming content signal, or such as data indicated by, for example, the Radio Data System (RDS) text data that frequently accompanies the programming content data for reception by a radio, such as a satellite radio. The indicator(s) may also be obtained from both data sets. At step 3, the indicator may be provided to the user, such as simultaneously or serially with, and such as via a display associated with the user's radio, the indicators for other channels available on the user's radio, such as for the user's preprogrammed channels.

At Step 4, a change may occur away from the channel then being listened to and entering a commercial break to another channel, such as another preprogrammed channel, that at that time includes programming content rather than commercials. The channel change may occur automatically, such as based on a previously entered user instruction as may be entered to a profile or the like, or may occur manually based on an input to the radio from the in-vehicle user. Further, the order of the selected next radio stations in an automated switching embodiment may be predetermined by the user, such as may be indicated by the order in which the preprogramming channels were preprogrammed by the user, that is, preprogrammed channel 1 may be most preferred by the user, followed by preprogrammed channel 2, followed by preprogrammed channel 3, and so on.

At Step 5, an indication may be received by the radio of the end of a commercial break on at least one channel not then being listened to by the user. The indication received at Step 5 may, for example, be included in the programming data or maybe included in the RDS data as referenced above, or may be included in both data sets. Further, such as in an RDS embodiment, the status of a plurality of radio stations not then being listened to by the user, such as the set or a subset of the users preprogrammed stations, may be displayed simultaneously or serially on a display associated with the user's radio. As used herein, simultaneous display may include the providing of multiple data at the same time on the display screen, while serial display may include, for example, scrolling of each data set, one after another, across the display screen.

For example, the programming or commercial status of a plurality of preprogrammed stations, such as six programmed stations, maybe indicated in small text on a display in the user's vehicle. More particularly, the station then being listened to may have its associated RDS data displayed in larger text, while the five other preprogrammed stations may have their respective associated RDS data indicated in a much smaller font on the display.

By way of more particular example, in typical RDS embodiments, particular types of messages indicate programming, while other types of RDS text indicate commercials. For example, during a talk radio program's active programming content, the RDS data may indicate the host of the radio program, or the name of the radio program, while during a commercial break the RDS text data may indicate a 1-800-number associated with a satellite radio provider, or may indicate available programming on other stations of the satellite radio programming that are not the station then associated with the RDS text. For example, a user may be listening to radio channel 79, and during a commercial break the RDS text may indicate that 1940's music is then available on radio channel 4. Because channel 79 is not channel 4, sensing of this text, either automatically by the radio (or, more particularly, the computer code associated therewith as executed by the radio's microprocessor(s)) or manually by the user, would readily indicate the occurrence of commercials on channel 79.

At Step 6, a direction may be received by the radio to change a channel to a different preprogrammed channel based on the presence of programming on that other preprogrammed channel. For example, if a user switches or indicates a switch from PP channel 2 to PP channel 4 based on the occurrence of a commercial on PP channel 2, the user may manually switch or automatically be switched from PP channel 4 back to PP channel 2 at the end of the commercial break on PP channel 2.

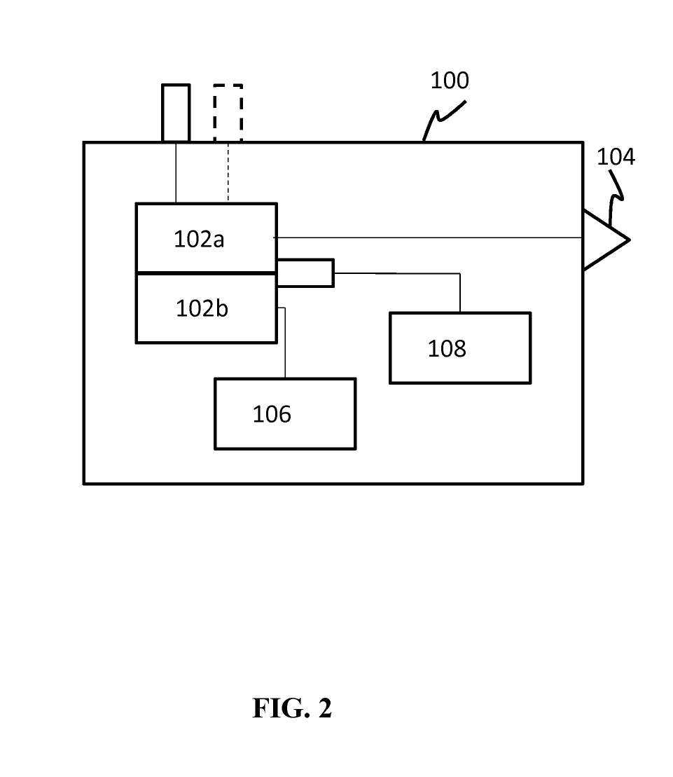

As will be understood by those of skill in the art in light of the discussion herein, the radio receiver may use presently available data to identify a change from programming to commercial and back again, such as through use of the aforementioned RDS text, or the radio receiver may use other parameters, such as by a change in a received content signal, signal strength, signal quality, or the like. Likewise, the methods and systems discussed above may be made available by a satellite carrier, such as through a specialized radio, and/or may be made available via an enhanced subscription fee, by way of non-limiting example. FIG. 2 illustrates such a radio 100 operable in accordance with the present disclosure.

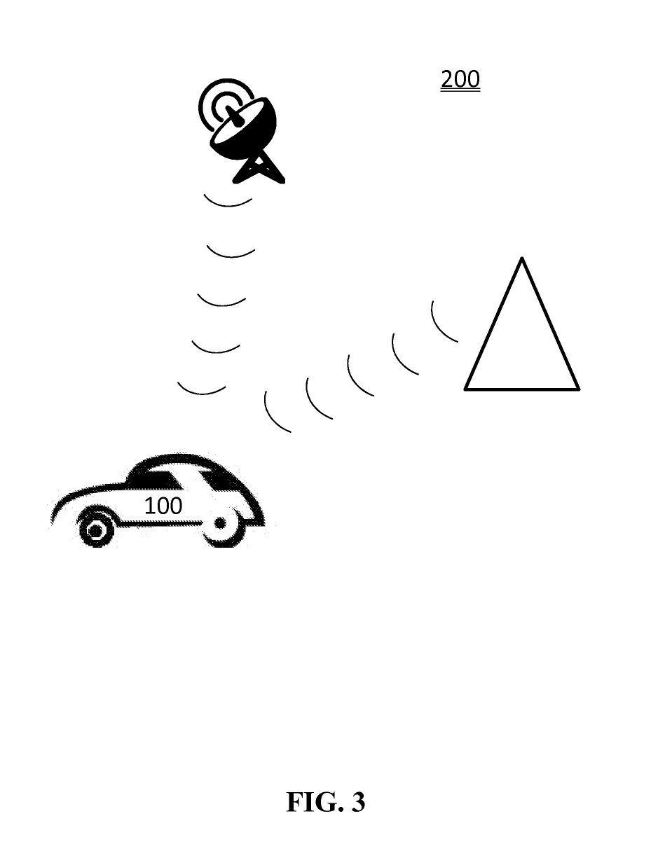

More particularly, FIG. 2 indicates a radio receiver 102a that receives satellite programming, has an output 104 to a vehicle for sound, and that includes a receiver 102b for a programming/commercial indicator, a display 106 for display of a plurality of the commercial/programming indicators, and a channel changing mechanism 108 that may operate automatically, manually, or both. Accordingly, the radio receiver of FIG. 2 is suitable for carrying out the method discussed hereinabove with respect to FIG. 1. FIG. 3 is a system diagram of a radio 100 operating within a system 200 suitable for carrying out the method 10 of FIG. 1.

In light of the disclosure above, it will be appreciated that other manner of delivering programming and commercials to a user maybe made available through the use of the foregoing apparatus, system, and method. For example, a user could have a television set preprogrammed with a subset of preferred channels. Moreover, the metadata associated with received television programming includes indicators of commercial breaks and active programming. Thereby, a text display may be provided that illustrates what is then occurring on the preferred channels, such as wherein certain of the channels are in commercial at a given time while others of the channels have programming at a given time. Such data may be displayed, for example, in smaller font text associated with a set top box, on an IPTV, via an overlay on the display that is constant on or activated by the user, or by like mechanisms. The user may then use this indicator to select to change as between preferred channels on a television set, or the channel may be automatically changed.

Of course, those skilled in the art will appreciate that other features may be made available by providing a radio or other audio-visual device with the monitoring means and methods discussed herein. For example, volume may be varied, or muted altogether, such as based on an entered user preference based on monitored content being provided. For example, a satellite radio may auto-mute when the RDS indicates commercials, and may automatically return volume to a preferred or prior setting when commercials are indicated as over. Thereby, a user adjusting the volume for, for example, commercials, and forgetting to monitor the RDS display to know when to readjust volume, or driving distracted by constantly watching the RDS text, is a problem that can be avoided.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is rather to be accorded the widest scope consistent with the principles and novel features disclosed herein.

What is claimed is:

1. A radio, comprising:
a receiver suitable for receiving programming content;
an audio output suitable for outputting the programming content as at least sound;
an indication receiver suitable for receiving indicators of the programming content on at least two channels received by the receiver;
a display suitable for simultaneous display of a plurality of ones of the indicators; and
a channel changer suitable for changing between the at least two channels in accordance with the plurality of the ones of the indicators.

2. The radio of claim 1, wherein the programming content comprises advertisements.

3. The radio of claim 1, wherein the indicators comprise radio data system text.

4. The radio of claim 1, wherein the simultaneous display comprises scrolling data.

5. The radio of claim 1, wherein the indicators provided to the channel changer meet a designated criteria.
